(19) United States
(12) Patent Application Publication
(10) Pub. No.: US 2006/0203737 A1
(43) Pub. Date: Sep. 14, 2006

(54) Traffic delay processing

(75) Inventor: Michael K. Bugenhagen, Olathe, KS (US)

Correspondence Address: SPRINT, 6391 SPRINT PARKWAY, KSOPHT0101-Z2100, OVERLAND PARK, KS, 66251-2100, US

(73) Assignee: Sprint Communications Company L.P.

(21) Appl. No.: 11/073,200

(22) Filed: Mar. 4, 2005

(51) Int. Cl. H04J 1/16

(52) U.S. Cl. 370/252

(57) ABSTRACT

A traffic processing system comprising a processing system and a delay buffer. The processing system is configured to determine a first delay metric for first traffic on a first path from the TPS to a first node, and determine a first delay differential based on the first delay metric and a second delay metric for second traffic on a second path from the TPS to a second node. The delay buffer is configured to delay the second traffic based on the first delay differential.

### RELATED APPLICATIONS

Not applicable

### FEDERALLY SPONSORED RESEARCH OR DEVELOPMENT

Not applicable

### MICROFICHE APPENDIX

Not applicable

### BACKGROUND OF THE INVENTION

1. Field of the Invention

The invention relates to telecommunications, and in particular, to traffic-synchronization systems for processing delay in telecommunication networks.

2. Description of the Prior Art

Wireless communication networks often times include wireless devices that transmit communications to base station transceivers. The base station transceivers transfer the communications over a backhaul to a mobile switching center (MSC). The MSC then routes the communications to their appropriate destination. T-1 lines are typically used for the backhaul. Packet based transports are also frequently used for the backhaul. For example, simulated T-1 over Ethernet is commonly used for the backhaul. Unfortunately, delay problems occur when both packet transports and T-1 lines are utilized for the backhaul in a communication network.

FIG. 1 illustrates telecommunication network 100 in an example of the prior art. Telecommunication network 100 includes MSC 110, base station 120, base station 125, base station 130, wireless device 140, and public switched telephone network (PSTN) 150. MSC 110 is coupled to base stations 120 and 125 by T-1 lines 111 and 113 respectively. Base station 130 is coupled to MSC by E-1 lines 112. Wireless device 140 is in communication with base stations 120, 125, and 130 using a wireless protocol, such as GSM or CDMA. MSC 110 is coupled to PSTN 150 by a trunk connection as is well known in the art.

During a call, wireless device 140 transmits communications simultaneously to base stations 120, 125, and 130. The communications transmitted from wireless device 140 are transported over both T-1 lines 111 and 113, and E-1 line 112. The communications arrive at MSC 110. MSC 110 selects the communications from either of the T-1 lines or the E-1 line. MSC 110 then routes the communications to their appropriate destination. Communications that are received into MSC 110 from the destination are routed to T-1 lines 111 and 113 and E-1 line 112. All three base stations 120, 125, and 130 then transmit the communications to wireless device 140. Wireless device 140 selects one of the three transmitted signals based upon several factors, such as their respective signal strengths.

As is well known in the art, backhaul connections typically involve some amount of delay. In this example, the delay associated with T-1 lines 111 and 113 are relatively similar. Thus, when MSC 110 switches between line 111 and line 113, the two communication streams from each line are adequately synchronized. Unfortunately, the delay associated with E-1 line 112 is often times unpredictable. In addition, the delay associated with E-1 line 112 is often times much greater than that of T-1 lines 111 and 113. As a result, packets arriving after the time interval where they can be used are discarded, and the end users experience call degradation when MSC 110 switches between one of the T-1 lines and E-1 line 112. For instance, the users hear a gap in their conversations. Even more problematically, the call could be dropped entirely.

### SUMMARY OF THE INVENTION

An embodiment of the invention helps solve the above problems and other problems by providing a traffic processing system that detects differences in path delay and synchronizes traffic arrival among several different paths. In an embodiment of the invention, a traffic processing system comprises a processing system and a tunable delay buffer. The processing system is configured to determine a first delay metric for first traffic on a first path from the TPS to a first node, and determine a first delay differential based on the first delay metric and a second delay metric for second traffic on a second path from the TPS to a second node. The delay buffer is configured to delay the second traffic based on the first delay differential.

In an embodiment of the invention, the processing system is further configured to determine a second delay differential based on the first delay metric and a third delay metric for third traffic on a third path from the TPS to a third node, and wherein the delay buffer is further configured to delay the third traffic based on the second delay differential.

In an embodiment of the invention, the traffic processing system further comprises an interface configured to transmit a timing request to the first node and receive an acknowledgment message from the first node in response to the timing request, and wherein the processing system is further configured to determine the first delay metric based on a time differential between the timing request and the acknowledgment message.

In an embodiment of the invention, the delay buffer is further configured to delay the second traffic based on the delay differential to synchronize the second traffic with the first traffic to within a synchronization parameter.

In an embodiment of the invention, the traffic processing system comprises a mobile switching center.

In an embodiment of the invention, the first node comprises a base station transceiver.

In an embodiment of the invention, the second node comprises a base station transceiver.

In an embodiment of the invention, the first path comprises a packet path.

In an embodiment of the invention, the second path comprises a time division multiplexed line.

In an embodiment of the invention, the first traffic comprises voice communications.

### BRIEF DESCRIPTION OF THE DRAWINGS

The same reference number represents the same element on all drawings.

FIG. 1 illustrates a telecommunication system in an example of the prior art.

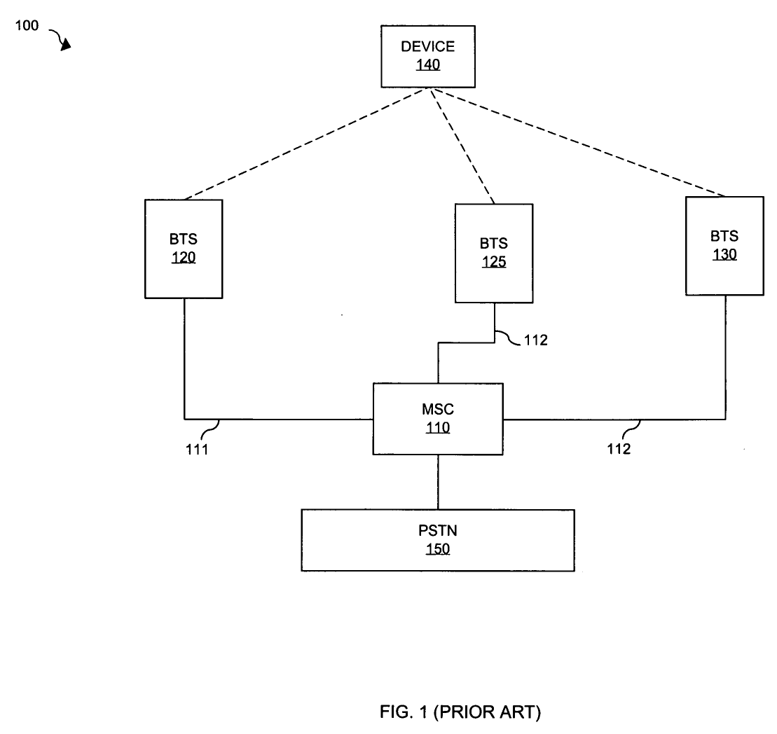

FIG. 2 illustrates a communication system in an embodiment of the invention.

FIG. 3 illustrates the operation of a communication system in an embodiment of the invention.

FIG. 4 illustrates a communication system in an embodiment of the invention.

FIG. 5 illustrates the operation of a communication system in an embodiment of the invention.

FIG. 6 illustrates a communication system in an embodiment of the invention.

FIG. 7 illustrates a computer system in an embodiment of the invention.

### DETAILED DESCRIPTION OF THE PREFERRED EMBODIMENT

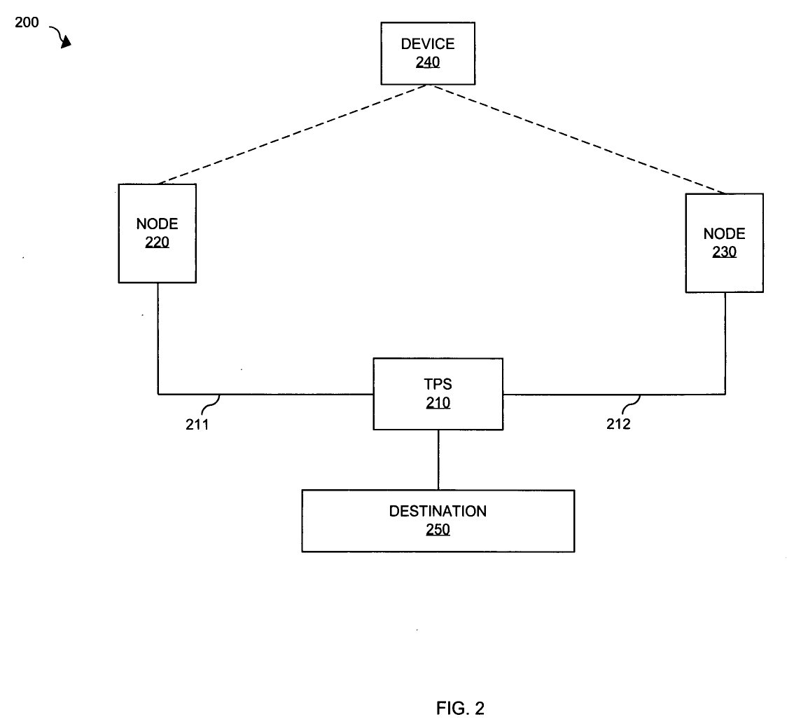

FIGS. 2-7 and the following description depict specific embodiments of the invention to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments of the invention. As a result, the invention is not limited to the specific embodiments described below, but only by the claims and their equivalents.

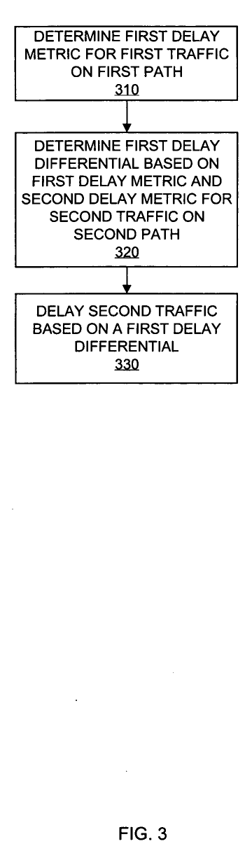

### First Embodiment Configuration and Operation—FIGS. 2 and 3

FIG. 2 illustrates communication network 200 in an embodiment of the invention. Communication network 200 includes traffic processing system (TPS) 210, node 220, node 230, and device 240. Node 220 is in communication with TPS 210 by path 211. Node 230 is in communication with TPS 210 by path 212. TPS 210 is also in communication with destination 250. Device 240 is in communication with both node 220 and node 230.

In this embodiment, device 240 could be in communication with node 220 and 230 simultaneously, transmitting and receiving communications between itself and nodes 220 and 230. In this example, upstream traffic will be considered traffic sent from destination 250 to TPS 210. TPS 210 receives and processes the upstream traffic, and transfers the upstream traffic along paths 211 and 212 to nodes 220 and 230. Nodes 220 and 230 then transmit the upstream traffic to device 240. Downstream traffic will be considered communications transferred from device 240 to node 220 and 230. The downstream traffic is then transferred along paths 211 and 212 to TPS 210.

FIG. 3 illustrates the operation of TPS 210 in an embodiment of the invention. It is assumed in this embodiment that, at any given time, TPS 210 uses traffic from both paths 211 and 212. For example, if node 220 provides a stronger signal to device 240, TPS 210 will use traffic from path 211 over traffic from path 212. However, the respective signal strengths of nodes 220 and 230 could change, thereby leading TPS 210 to alter which path it utilizes. In this case, downstream traffic along path 212 could be significantly delayed as compared to downstream traffic along path 211. Similarly, upstream traffic along path 212 could also be significantly delayed as compared to upstream traffic along path 211.

To synchronize the downstream traffic across paths 211 and 212, TPS 210 first determines a first delay metric for the downstream traffic on path 212 (Step 310). The first delay metric could be, for example, the amount of time it takes for a packet message to reach node 230 from TPS 210 along path 212. Next, TPS 210 determines a first delay differential based on the first delay metric and a second delay metric for the downstream traffic on path 211 (Step 320). The second delay metric could be, for example, the amount of time it takes for a packet message to reach node 220 from TPS 210 along path 211. TPS 210 then delays the downstream traffic from path 211 based on the first delay differential (Step 330). For example, if the delay differential is 2 milliseconds, the downstream traffic from path 211 is delayed by 2 milliseconds.

In this manner, slower downstream traffic from path 212 is now synchronized with downstream traffic from path 211. Advantageously, when TPS 210 switches between paths 211 and 212, the downstream traffic from each path is synchronized. Destination 250 will no longer experience communication degradation, such as gaps or dropped sessions. A similar process can be applied to upstream traffic whereby TPS 210 delays upstream traffic for path 211 relative to the upstream traffic sent along path 212. The two upstream traffic flows along paths 211 and 212 will therefore each reach nodes 220 and 230 nearly simultaneously. The communications transmitted by nodes 220 and 230 will also therefore reach device 240 nearly simultaneously.

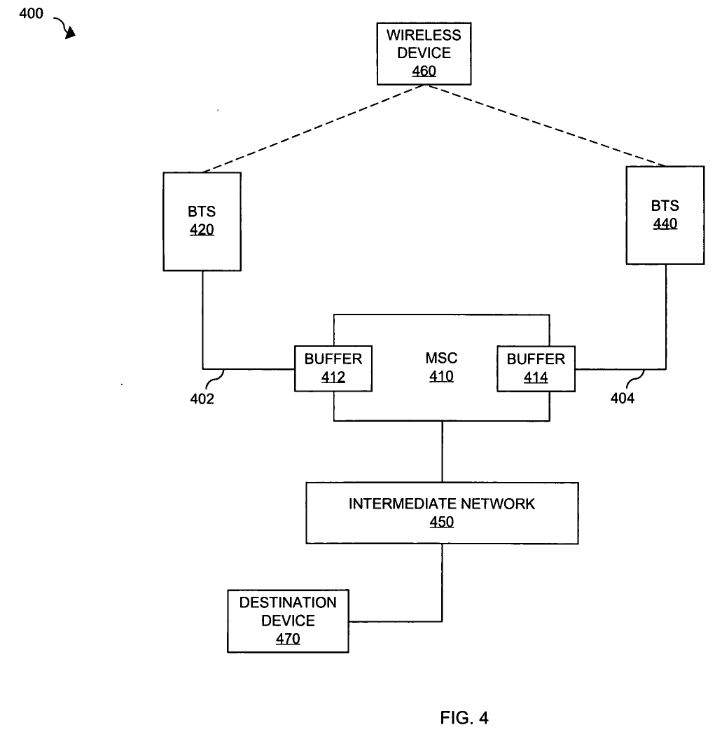

### Second Embodiment Configuration and Operation—FIGS. 4-6

FIG. 4 illustrates communication network 400 in an embodiment of the invention. Communication network 400 includes mobile switching center (MSC) 410, base station transceiver (BTS) 420, BTS 440, wireless device 460, intermediate network 450, and destination device 470. MSC 410 includes differential delay buffers 412 and 414. BTS 420 is in communication with MSC 410 over path 402. BTS 440 is in communication with MSC 410 over path 404. Wireless device 460 is in communication with BTS 420 and BTS 440 using a wireless communication protocol, such as CDMA, TDMA, and GSM, as well as other protocols. MSC 410 is in communication with intermediate network 450 in a manner well known in the art. Intermediate network 450 could be, for example, the public switched telephone network (PSTN), as well as other types of networks that would reside between wireless device 460 and destination device 470.

In this embodiment, wireless device 460 has established a service session with destination device 470. The service session could be, for example, a voice call, a data session, or a real-time video session, as well as other types of sessions. Wireless device 460 transmits session traffic simultaneously to BTS 420 and BTS 440. BTS 420 transfers the traffic along path 402 to MSC 410. BTS 440 transfers the traffic along path 404 to MSC 410. Path 402 could be, for example, a time division multiplexed (TDM) path, such as a T-1 line. Path 404 could be, for example, a packet based path, such as a Pseudo Wire connection, an emulated T-1 over Ethernet connection, or a Fast Ethernet connection, as well as other types of paths.

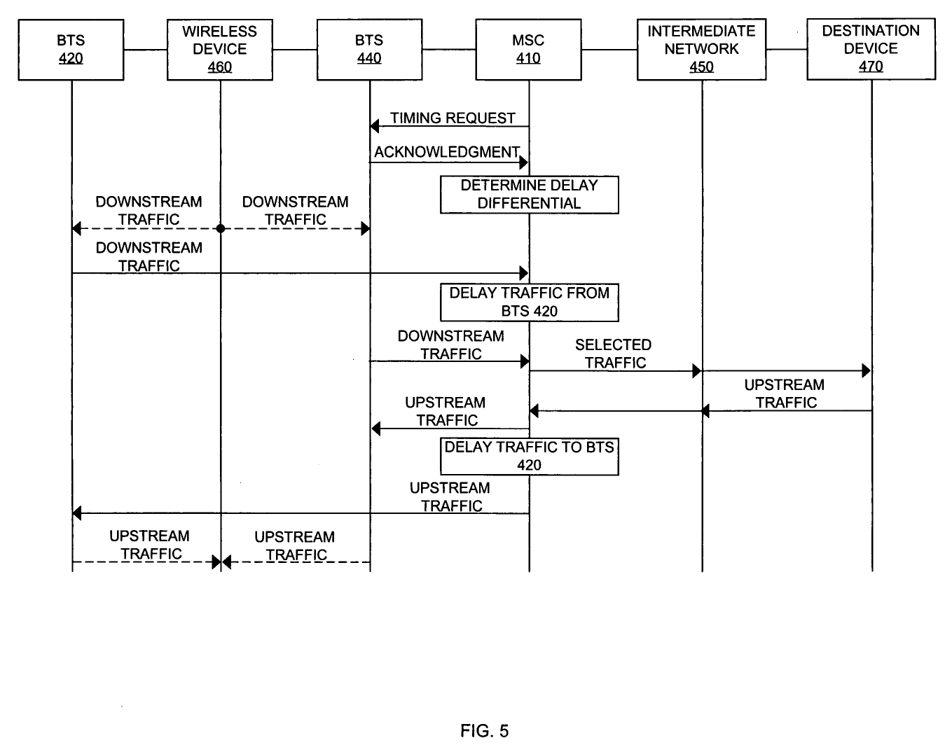

As discussed with respect to the prior art, path 402 incurs a different amount of delay than path 404. For instance, traffic sent over path 402 from BTS 420 will arrive at MSC 410 earlier than traffic sent over path 404 from PTS 440. Similarly, traffic sent from MSC 410 to BTS 420 will arrive earlier than traffic sent from MSC 410 to BTS 440. To overcome this limitation, MSC 410 determines a delay differential based on the delay of path 402 and the delay of path 404. FIG. 5 is a flow chart illustrating a messaging sequence for determining the delay differential.

To begin, MSC 410 transfers a timing request to BTS 440. The timing request could be a packet message requesting a time stamp from BTS 440. BTS 440 would receive the packet message and return an acknowledgment message in response to the timing request. The acknowledgment message could include the time stamp. MSC 410 would then determine a delay metric for path 404 based on the roundtrip time elapsed between sending the timing request and receiving the acknowledgment message. MSC 410 could also determine the delay metric based on the time elapsed between the time stamp included in the acknowledgment message and the time the acknowledgment message was received into MSC 410.

MSC 410 could perform a similar operation with respect to BTS 420 and path 402 to determine a delay metric for path 402. Alternatively, the delay metric for 402 could be predetermined or already known. The delay differential is therefore determined based on the delay metric for path 404 and the delay metric for path 402. The delay differential could be stated in terms of a unit of time, a number of packets, or a number of frames, as well as in other ways.

In this embodiment, it is assumed that the delay metric for path 404 is greater than the delay metric for path 402. In other words, traffic transmitted along path 404 travels at a slower rate than traffic transmitted along path 402. As a consequence, the traffic from BTS 420 is out of synch with the traffic from BTS 440. This causes traffic degradation when MSC 410 switches between path 402 and 404. To correct this problem, MSC 410 delays the traffic from path 402 based on the delay differential. For instance, if the delay differential is 2 milliseconds, MSC 410 delays the traffic from path 402 by 2 milliseconds. In this manner, the traffic from path 402 is synchronized with the traffic from path 404. Advantageously, this allows MSC 410 to switch between paths 402 and 404 without causing any traffic degradation.

With respect to upstream traffic flow, destination device 470 transfers traffic across intermediate network 450 to MSC 410. In the prior art, MSC 410 would typically transfers the traffic simultaneously to BTS 420 and BTS 440. However, traffic sent along path 404 will be out of synch with traffic sent along path 402. As a consequence, traffic degradation will occur if wireless device 460 switches between traffic streams. For instance, a user will experience a gap in the service session. As discussed above, this problem is solved by delaying the traffic on path 402 relative to the traffic on path 404. After determining the delay differential, MSC 410 delays the traffic on path 402 based on the delay differential. In this manner, traffic arriving at wireless device 460 from BTS 420 and BTS 440 is synchronized. Advantageously, this allows wireless device 460 to switch between BTS 420 and BTS 440 as the primary base station transceiver.

It should be understood that the delay differential need not be zero for paths 402 and 404 to be considered synchronized. Rather, an acceptable parameter could be agreed upon, whereby delay differentials exceeding the parameter would cause MSC 410 to delay traffic on one path or the other. It should also be understood that paths 402 and 404 could be virtual local area networks (VLANS), virtual wide area network (VWAN), or IP tunnels, as well as other types of paths. A protocol such as the real-time transport protocol (RTP) or RTP control protocol (RTCP) could be utilized for determining the delay metrics. It should also be understood that MSC 410 controls delay buffer 412 for traffic sent and received on path 402. Likewise, MSC 420 controls delay buffer 414 for traffic sent and received on path 404. Delay buffers 412 and 414 could be, for example, jitter buffers modified to operate in accordance with FIG. 5.

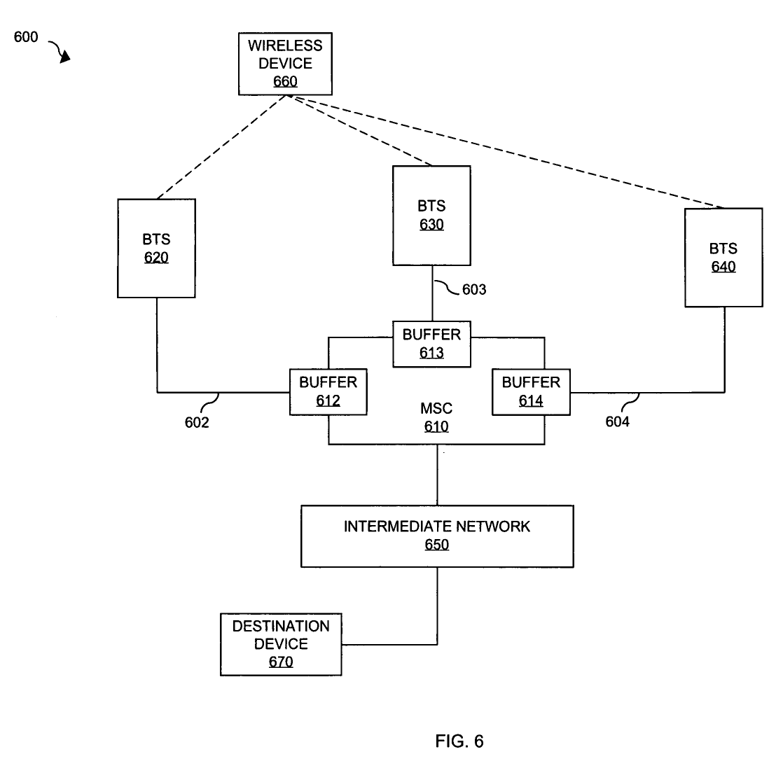

FIG. 6 illustrates communication network 600 in an embodiment of the invention. Communication network 600 includes MSC 610 having delay buffers 612, 613, and 614. MSC 610 is in communication with BTS 620, BTS 630, and BTS 640 over communication paths 602, 603, and 604 respectively. Wireless device 660 is in. communication with BTSs 620, 630, and 640 by a wireless communication protocol well known in the art, such as CDMA, TDMA, or GSM. MSC 610 is also in communication with intermediate network 650. Destination device 670 is coupled to intermediate network 650.

In this embodiment of the invention, MSC 610 operates as described above with respect to MSC 410. However, communication network 600 includes an additional BTS-BTS 630. In such a case, MSC 610 must perform additional operations to balance out the delay associated with all three paths 602, 603, and 604. Consider a case wherein the delay metric for path 604 is greater than the delay metric for path 603, and wherein the delay metric for path 603 is greater than the delay metric for path 602. In this case, MSC 610 will adjust buffer 612 so that traffic on path 602 is synchronized with the slowest path path 604. However, path 603 will remain unsynchronized with respect to path 602 and 604. MSC. 610 will therefore also adjust buffer 613 so that traffic on path 603 is synchronized with path 604 and path 602. In another case, path 603 could be initially synchronized with path 602. However, upon MSC 610 adjusting buffer 612, path 603 would then be out of synch with path 602. In response, MSC 610 would adjust buffer 613.

In this embodiment, MSC 610 could determine several different delay differentials. For instance, a delay deferential could be calculated between path 602 and 603. Similarly, a delay differential could be calculated between path 602 and 604, or between path 603 and 604. Regardless, by adjusting one of buffers 612, 613, or 614, the delay differentials are also affected. It is therefore necessary for MSC 610 to reevaluate the delay differentials to determine if further adjustments are required.

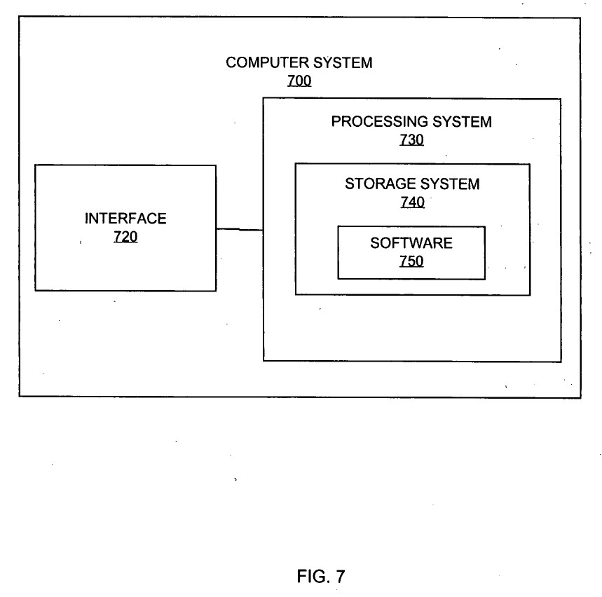

FIG. 7 illustrates computer system 700 in an embodiment of the invention. Computer system 700 includes interface 720, processing system 730, storage system 740, and software 750. Storage system 740 stores software 750. Processing system 730 is linked to interface 720. Computer system 700 could be comprised of a programmed general-purpose computer, although those skilled in the art will appreciate that programmable or special purpose circuitry and equipment may be used. Computer system 700 may use a client server architecture where operations are distributed among a server system and client devices that together comprise elements 720-750.

Interface 720 could comprise a network interface card, modem, port, or some other communication device. Signaling interface 720 may be distributed among multiple communication devices. Interface 730 could comprise a computer microprocessor, logic circuit, or some other processing device. Processing system 730 may be distributed among multiple processing-devices. Storage system 740 could comprise a disk, tape, integrated circuit, server, or some other memory device. Storage system 740 may be distributed among multiple memory devices.

Processing system 730 retrieves and executes software 750 from storage system 740. Software 750 may comprise an operating system, utilities, drivers, networking software, and other software typically loaded onto a general-purpose computer. Software 750 could also comprise an application program, firmware, or some other form of machine-readable processing instructions. When executed by the processing system 730, software 750 directs processing system 730 to operate as described for TPS 210, MSC 410, and MSC 610.

What is claimed is:

1. A method of operating a traffic processing system, the method comprising:
determining a first delay metric for first traffic on a first path from the TPS to a first node;
determining a first delay differential based on the first delay metric and a second delay metric for second traffic on a second path from the TPS to a second node; and
delaying the second traffic based on the first delay differential.

2. The method of claim 1 further comprising determining a second delay differential based on the first delay metric and a third delay metric for third traffic on a third path from the TPS to a third node, and delaying the third traffic based on the second delay differential.

3. The method of claim 1 further comprising transmitting a timing request to the first node and receiving an acknowledgment message from the first node in response to the timing request and determining the first delay metric based on a time differential between the timing request and the acknowledgment message.

4. The method of claim 1 further comprising delaying the second traffic based on the delay differential to synchronize the second traffic with the first traffic to within a synchronization parameter.

5. The method of claim 1 wherein the TPS comprises a mobile switching center.

6. The method of claim 1 wherein the first node comprises a base station transceiver.

7. The method of claim 1 wherein the second node comprises a base station transceiver.

8. The method of claim 1 wherein the first path comprises a packet path.

9. The method of claim 8 wherein the second path comprises a time division multiplexed line.

10. The method of claim 1 wherein the first traffic comprises voice communications.

11. A traffic processing system comprising:
a processing system configured to determine a first delay metric for first traffic on a first path from the TPS to a first node, and determine a first delay differential based on the first delay metric and a second delay metric for second traffic on a second path from the TPS to a second node; and
a delay buffer configured to delay the second traffic based on the first delay differential.

12. The traffic processing system of claim 11 wherein the processing system is further configured to determine a second delay differential based on the first delay metric and a third delay metric for third traffic on a third path from the TPS to a third node, and wherein the delay buffer is further configured to delay the third traffic based on the second delay differential.

13. The traffic processing system of claim 11 further comprising an interface configured to transmit a timing request to the first node and receive an acknowledgment message from the first node in response to the timing request, and wherein the processing system is further configured to determine the first delay metric based on a time differential between the timing request and the acknowledgment message.

14. The traffic processing system of claim 11 wherein the delay buffer is further configured to delay the second traffic based on the delay differential to synchronize the second traffic with the first traffic to within a synchronization parameter.

15. The traffic processing system of claim 11 wherein the TPS comprises a mobile switching center.

16. The traffic processing system of claim 11 wherein the first node comprises a base station transceiver.

17. The traffic processing system of claim 11 wherein the second node comprises a base station transceiver.

18. The traffic processing system of claim 11 wherein the first path comprises a packet path.

19. The traffic processing system of claim 18 wherein the second path comprises a time division multiplexed line.

20. The traffic processing system of claim 11 wherein the first traffic comprises voice communications.

21. A software product for operating a traffic processing system, the software product comprising:
software operation when executed by a processor to direct the processor to determine a first delay metric for first traffic on a first path from the TPS to a first node, determine a first delay differential based on the first delay metric and a second delay metric for second traffic on a second path from the TPS to a second node, and delay the second traffic based on the first delay differential; and
a storage medium configured to store the software.
